(19) United States
(12) Patent Application Publication
(10) Pub. No.: US 2025/0015292 A1
(43) Pub. Date: Jan. 9, 2025

(54) Electrode Mixture Layer-forming Composition for Lithium-Sulfur Secondary Battery, Electrode of Lithium-Sulfur Secondary Battery, and Lithium-Sulfur Secondary Battery

(71) Applicants: TOAGOSEI CO., LTD., Minato-ku, Tokyo (JP); THE SCHOOL CORPORATION KANSAI UNIVERSITY, Suita-shi, Osaka (JP)

(72) Inventors: Naohiko SAITO, Nagoya-shi, Aichi (JP); Tomoko NAKANO, Nagoya-shi, Aichi (JP); Daisuke OKUDA, Suita-shi, Osaka (JP); Chihiro MURATA, Suita-shi, Osaka (JP); Masashi ISHIKAWA, Suita-shi, Osaka (JP)

(73) Assignees: TOAGOSEI CO., LTD., Minato-ku, Tokyo (JP); THE SCHOOL CORPORATION KANSAI UNIVERSITY, Suita-shi, Osaka (JP)

(21) Appl. No.: 18/711,343

(22) PCT Filed: Nov. 17, 2022
(86) PCT No.: PCT/JP2022/042744

§ 371 Date: May 17, 2024

(30) Foreign Application Priority Data
Nov. 18, 2021 (JP) 2021-187760

(51) Int. Cl. H01M 4/62; C09D 5/24; C09D 7/43; C09D 7/62; C09D 7/65; C09D 133/02; H01M 4/13; H01M 4/38; H01M 10/052

(52) U.S. Cl. CPC H01M 4/623; C09D 5/24; C09D 7/43; C09D 7/62; C09D 7/65; C09D 133/02; H01M 4/13; H01M 4/38; H01M 10/052

(57) ABSTRACT

An electrode mixture layer-forming composition for a lithium-sulfur secondary battery, said composition contains a carboxyl group-containing polymer or a salt thereof serving as a binder, a sulfur-based active material, a thickening agent, and water.

### CROSS-REFERENCE TO RELATED APPLICATIONS

The present application claims the benefit of Japanese Patent Application No. 2021-187760 filed on Nov. 18, 2021, the disclosure of which is incorporated herein by reference.

### TECHNICAL FIELD

The present disclosure relates to an electrode mixture layer-forming composition for a lithium-sulfur secondary battery, to an electrode of a lithium-sulfur secondary battery, and to a lithium-sulfur secondary battery.

### BACKGROUND ART

A variety of electrical power storage devices, including a nickel-hydrogen secondary battery, a lithium ion secondary battery, and an electric double layer capacitor, have been practically used as secondary batteries. Among such secondary batteries, a lithium ion secondary battery finds a wide range of uses by virtue of high energy density and high battery capacity. In recent years, a lithium-sulfur secondary battery has attracted attention, the battery employing a sulfur-based active material as a positive electrode active material instead of a transition metal oxide (e.g., lithium cobaltate) conventionally employed in a lithium ion secondary battery.

Generally similar to a lithium ion battery, the lithium-sulfur secondary battery includes a positive electrode, a negative electrode, and an electrolyte, and charge-discharge occurs through transfer of lithium ions between the electrodes by the mediation of the electrolyte. The positive electrode and the negative electrode are each provided by forming an electrode mixture layer containing an active material on a surface of a current collector made of a metal foil or the like. Sulfur, which is used as a positive electrode active material of a lithium-sulfur secondary battery, exhibits a theoretical capacity density as high as 1672 mAh/g. Thus, a lithium-sulfur secondary battery is a promising candidate as a high-capacity battery.

On the other hand, in such a lithium-sulfur secondary battery, during discharge sulfur is transformed into lithium polysulfide through stepwise reduction, and the formed sulfide is readily eluted into an electrolytic solution. Therefore, the lithium-sulfur secondary battery problematically exhibits poor cycle characteristics and short service life. Also, sulfur undergoes considerable change in volume during a charge/discharge process. In repeated use of the lithium-sulfur secondary battery, delamination, peeling, and the like of the electrode mixture layer occur, to thereby cause a drop in battery capacity. That is another cause of such a short service life.

Hitherto, in order to solve the aforementioned problems, a poly(acrylic acid)-based binder has been used for binding the active material so as to improve the battery capacity and the service life of the lithium-sulfur secondary battery (see, for example, Patent Documents 1 and 2).

Patent Document 1 discloses production of the positive electrode of a lithium-sulfur secondary battery by forming an electrode mixture layer containing a sulfur-based active material on the surface of a current collector by use of an electrode binder containing lithium polyacrylate and poly(vinyl alcohol). Patent Document 2 discloses use, as a binder, of two or more lithium-substituted poly(acrylic acid) species having different molecular weights.

### PRIOR ART DOCUMENTS

### Patent Documents

Patent Document 1: WO 2019/132394
Patent Document 2: WO 2019/107815

### SUMMARY OF THE INVENTION

### Problems to be Solved by the Invention

Generally, the positive electrode of a lithium-sulfur secondary battery is produced by applying a composition containing a sulfur-based active material, a binder, a medium, etc. (i.e., an electrode mixture layer-forming composition) onto a surface of a current collector, and by removing the medium. From the viewpoint of reducing an environmental load, water is preferably used as a medium which is incorporated into an electrode mixture layer-forming composition.

However, when the electrode mixture layer-forming composition containing a sulfur-based active material employs water as a medium, aggregation of the sulfur-based active material tends to occur, and when the electrode mixture layer-forming composition is applied onto the surface of the current collector, the surface of a current collector is provided with irregular lines and roughness, which is problematic. Thus, when applicability of the electrode mixture layer-forming composition is insufficient, possibly, the surface flatness of the electrode decreases, whereby a lithium-sulfur secondary battery exhibiting suitable battery performance fails to be produced.

When an electrode mixture layer is formed by removing water from the electrode mixture layer-forming composition applied onto the surface of the current collector, cracking may occur in the surface of an electrode mixture layer. Particularly when the thickness of the electrode mixture layer is intended to increase for the purposes of enhancing the battery capacity of the lithium-sulfur secondary battery or other reasons, cracking tends to occur on the surface of the electrode mixture layer due to an increase in layer thickness. In the case where an electrode mixture layer with such cracking is used, the battery performance of the lithium-sulfur secondary battery may be impaired. Thus, there is demand for an electrode material which can prevent such cracking.

The present disclosure has been made under such circumstances. Thus, a main object of the present disclosure is to provide an electrode mixture layer-forming composition for a lithium-sulfur secondary battery, which composition has excellent applicability, generates less cracking in the electrode mixture layer, and can obtain a lithium-sulfur secondary battery exhibiting excellent output characteristics and cycle characteristics.

### Means for Solving the Problems

The present disclosure provides the following means.
[1] An electrode mixture layer-forming composition for a lithium-sulfur secondary battery, which composition contains a polymer having a carboxyl group (hereinafter referred to as a “carboxyl group-containing polymer”) or a salt thereof serving as a binder, a sulfur-based active material, a thickening agent, and water.
[2] The electrode mixture layer-forming composition according to [1] above, wherein the carboxyl group-containing polymer includes a structural unit (UA) derived from an ethylenically unsaturated monomer and having a carboxyl group, and the carboxyl group-containing polymer contains the structural unit in a relative amount, with respect to all the structural units of the carboxyl group-containing polymer, of 50 mass % or more.
[3] The electrode mixture layer-forming composition according to [1] or [2] above, wherein the carboxyl group-containing polymer includes a structural unit derived from an ethylenically unsaturated monomer (B) having no carboxyl group (except for a cross-linkable monomer), and the carboxyl group-containing polymer contains the structural unit derived from an ethylenically unsaturated monomer (B) in a relative amount, with respect to all the structural units of the carboxyl group-containing polymer, of 1 mass % to 50 mass %. [4] The electrode mixture layer-forming composition according to [3] above, which contains an ethylenically unsaturated monomer having a solubility of 10 g or more in 100 g of water at 20° C., as the ethylenically unsaturated monomer (B).
[5] The electrode mixture layer-forming composition according to any one of [1] to [4] above, wherein the carboxyl group-containing polymer is a cross-linked polymer.
[6] The electrode mixture layer-forming composition according to [5], wherein the cross-linked polymer includes a structural unit derived from a cross-linkable monomer and a structural unit derived from a non-cross-linkable monomer.
[7] The electrode mixture layer-forming composition according to [6], wherein the cross-linked polymer includes the structural unit derived from a cross-linkable monomer in a relative amount, with respect to the entire amount of the structural unit derived from a non-cross-linkable monomer, of 0.1 mol % to 2.0 mol %.
[8] The electrode mixture layer-forming composition according to any one of [5] to [7] above, wherein the cross-linked polymer has a particle size of 0.1 μm to 7.0 μm as a volume-basis median diameter, as determined in a water medium after neutralization to a neutralization degree of 80 mol % or higher.
[9] The electrode mixture layer-forming composition according to any one of [1] to [8] above, which contains a substituted product of a cellulose-based water-soluble polymer in which at least a part of hydroxy groups have been substituted by a carboxymethyl group, or a salt thereof, as the thickening agent.
[10] The electrode mixture layer-forming composition according to any one of [1] to [9] above, which contains at least one of elemental sulfur and a sulfur-based compound as the sulfur-based active material.
[11] The electrode mixture layer-forming composition according to above, wherein the sulfur-based compound is a carbon-sulfur composite in which sulfur is supported by pores of a porous carbon powder having a mean pore size of 100 nm or smaller.
[12] The electrode mixture layer-forming composition according to any one of [1] to above, which further contains a conducting aid.
[13] An electrode of a lithium-sulfur secondary battery, the electrode having a current collector, and an electrode mixture layer disposed on a surface of the current collector, wherein the electrode mixture layer is formed from an electrode mixture layer-forming composition as recited in any one [1] of [12] to above.
[14] A lithium-sulfur secondary battery having a lithium-sulfur secondary battery electrode as recited in above.

### Advantageous Effects of the Invention

According to the present disclosure, an electrode mixture layer-forming composition containing a carboxyl group-containing polymer or a salt thereof serving as a binder, a sulfur-based active material, a thickening agent, and water is provided, whereby suitable applicability (coatability) can be achieved, and cracking of the electrode mixture layer can be suppressed. Further, according to the present disclosure, a lithium-sulfur secondary battery exhibiting excellent output characteristics and cycle characteristics can be provided.

### MODES FOR CARRYING OUT THE INVENTION

The present disclosure will next be described in detail. In the present specification, the expression “(meth)acrylic” refers to acrylic and/or methacrylic. Similarly, “(meth)acrylate” refers to acrylate and/or methacrylate.

### <<Electrode Mixture Layer-Forming Composition>>

The electrode mixture layer-forming composition of the present disclosure (hereinafter may also be referred to simply as “the present composition”) is an electrode material for use in production of an electrode of a lithium-sulfur secondary battery (more specifically, an electrode mixture layer of a positive electrode). The electrode mixture layer-forming composition of the present disclosure contains a carboxyl group-containing polymer or a salt thereof serving as a binder, a sulfur-based active material, a thickening agent, and water. Hereinafter, the components contained in the present composition will be described in detail.

### <Carboxyl Group-Containing Polymer or a Salt Thereof>

The present composition contains a carboxyl group-containing polymer or a salt thereof (hereinafter may also be referred to as a “carboxyl group-containing polymer (or a salt thereof)”) as a binder for binding the components (e.g., an active material) contained in the electrode mixture layer. By using the carboxyl group-containing polymer (or a salt thereof) as a binder for binding a sulfur-based active material, even in the case of forming a thick electrode mixture layer, cracking of an electrode surface is prevented. Thus, a drop in battery performance and in production efficiency, which would otherwise be caused by cracking of an electrode surface, can be suppressed. Also, the carboxyl group-containing polymer (or a salt thereof) can be dissolved or dispersed in water. Thus, according to the present composition employing the carboxyl group-containing polymer (or a salt thereof) as the binder, the amount of organic solvent used in production of a lithium-sulfur secondary battery can be reduced, leading to reduction of an environmental load.

No particular limitation is imposed on the carboxyl group-containing polymer (or a salt thereof), so long as the polymer has a group represented by “—COOH” and/or “[—COO⁻]ₙRⁿ⁺” (wherein Rⁿ⁺ represents a counter ion to “—COO⁻”; and n is an integer of 1 or greater (preferably 1 or 2)). That is, the “carboxyl group-containing polymer (or a salt thereof)” may be an un-neutralized polymer, a partial neutralization product thereof in which a part of the carboxyl groups are neutralized, or a complete neutralization product thereof in which the entire carboxyl groups are neutralized. As used herein, among the polymers having a carboxyl group (or a salt thereof), the un-neutralized polymer is referred to as a “carboxyl group-containing polymer”, and the polymer in which a part or the entirety of the carboxyl groups are neutralized is referred to as a “salt of a carboxyl group-containing polymer”. As the carboxyl group-containing polymer (or a salt thereof), a polymer predominantly including a structural unit derived from an ethylenically unsaturated monomer is preferably used. More specifically, the polymer includes a structural unit derived from an ethylenically unsaturated monomer in a relative amount, with respect to all the structural units of the carboxyl group-containing polymer (or a salt thereof), of 50 mass % or more, preferably 70 mass % or more, more preferably 90 mass % or more.

### (Carboxyl Group-Containing Polymer)

As the carboxyl group-containing polymer, there is preferably used a carboxyl group-containing polymer which includes a structural unit derived from an ethylenically unsaturated monomer and having a carboxyl group (hereinafter may also be referred to as a structural unit (UA)). Examples of the structural unit (UA) include a structural unit derived from an ethylenically unsaturated monomer having a carboxyl group (hereinafter may also be referred to as a “monomer (A)”).

Specific examples of the monomer (A) include (meth)acrylic acid, itaconic acid, crotonic acid, maleic acid, fumaric acid, citraconic acid, cinnamic acid, monohydroxyethyl (meth)acrylate succinate, ω-carboxy-caprolactone mono(meth)acrylate, β-carboxyethyl (meth)acrylate, and 4-carboxystyrene. Among these monomers (A), (meth)acrylic acid is preferred.

The method of producing the carboxyl group-containing polymer is not limited to a production method employing the monomer (A). In one alternative production method, a (meth)acrylate ester monomer is polymerized, and the formed polymer is hydrolyzed, to thereby yield the target polymer. In a yet alternative production method, a nitrogen-containing monomer such as (meth)acrylamide or (meth)acrylonitrile is polymerized, and the formed polymer is treated with a strong alkali, to thereby yield the target polymer. In a still alternative production method, a polymer having a hydroxyl group is reacted with an acid anhydride, to thereby yield the target polymer. Through any of the above methods, a polymer including the structural unit (UA) can be produced as the carboxyl group-containing polymer.

In the carboxyl group-containing polymer, the relative amount of the structural unit (UA), with respect to all the structural units forming the carboxyl group-containing polymer, is preferably 50 mass % or more, more preferably 55 mass % or more, still more preferably 65 mass % or more, yet more preferably 75 mass % or more. When the structural unit (UA) content of the carboxyl group-containing polymer satisfies the above conditions, the cycle characteristics of the produced lithium-sulfur secondary battery can be enhanced, which is preferred. The structural unit (UA) forming the carboxyl group-containing polymer may be a single species or two or more species.

Alternatively, the carboxyl group-containing polymer may be formed of only the structural unit (UA). Yet alternatively, the carboxyl group-containing polymer may further include a structural unit derived from an ethylenically unsaturated monomer having no carboxyl group (except for a cross-linkable monomer, hereinafter may also be referred to simply as a “monomer (B)”). Hereinafter, the structural unit derived from the monomer (B) may also be referred to as a “structural unit (UB)”. By the structural unit (UB) included in the carboxyl group-containing polymer, preferably, an excessive rise in viscosity of the present composition can be suppressed, thereby enhancing applicability of the present composition; and output characteristics of the produced lithium-sulfur secondary battery can be enhanced.

The carboxyl group-containing polymer preferably includes, as the structural unit (UB), a structural unit (UB-1) derived from an ethylenically unsaturated monomer having a solubility of 10 g or more in 100 g of water at 20° C. (hereinafter may also be referred to as a “monomer (b1)”). The case where the carboxyl group-containing polymer includes the structural unit (UB-1) is preferred, since applicability of the present composition, suppression of cracking of the electrode formed from the present composition, and output characteristics and cycle characteristics of the lithium-sulfur secondary battery can be attained in a well-balanced manner.

Specific examples of the monomer (b1) include 2-hydroxyethyl (meth)acrylate, 2-hydroxypropyl (meth)acrylate, 3-hydroxypropyl (meth)acrylate, 4-hydroxybutyl (meth)acrylate, 2-(dimethylamino)ethyl (meth)acrylate, (meth)acrylamide, 2-hydroxyethyl(meth)acrylamide, 2-(meth)acrylamide-2-methyl-1-propanesulfonic acid, N-[3-(dimethylamino) propyl] (meth)acrylamide, poly(ethylene glycol) methyl ether (meth)acrylate, N, N-dimethyl(meth)acrylamide, 4-(meth)acryloylmorpholine, N-isopropyl(meth)acrylamide, (meth)ally alcohol, and sodium 4-vinylbenzenesulfonate. These monomers (b1) may be singly or in combination of two or more species.

From the viewpoints of achieving the higher effects of improving applicability of the present composition, suppression of cracking of the electrode, and output characteristics and cycle characteristics of the lithium-sulfur secondary battery, the monomer (b1) is preferably, among others, a hydroxy group-containing ethylenically unsaturated monomer, with at least one species selected from the group consisting of hydroxyalkyl (meth)acrylates and hydroxyalkyl(meth)acrylamides being more preferred.

In the case where the carboxyl group-containing polymer includes the structural unit (UB-1), the relative amount of the structural unit (UB-1), with respect to all the structural units forming the carboxyl group-containing polymer, is preferably 1 mass % or more, more preferably 2 mass % or more, still more preferably 5 mass % or more. From the viewpoint of securing dispersibility of the active material(s) contained in the present composition, the relative amount of the structural unit (UB-1), with respect to all the structural units forming the carboxyl group-containing polymer, is preferably 50 mass % or less, more preferably 40 mass % or less, still more preferably 30 mass % or less. These structural units (UB-1) each forming the carboxyl group-containing polymer may be a single species or two or more species.

Examples of the monomer (B) include the monomer (b1) and alkyl (meth)acrylate ester, alicyclic (meth)acrylate ester, aromatic (meth)acrylate ester, and alkoxyalkyl (meth)acrylate ester.

Specific examples of the alkyl (meth)acrylate ester include methyl (meth)acrylate, ethyl (meth)acrylate, isopropyl (meth)acrylate, n-propyl (meth)acrylate, n-butyl (meth)acrylate, isobutyl (meth)acrylate, tert-butyl (meth)acrylate, hexyl (meth)acrylate, and 2-ethylhexyl (meth)acrylate.

Specific examples of the alicyclic (meth)acrylate ester include cyclohexyl (meth)acrylate, methylcyclohexyl (meth)acrylate, tert-butylcyclohexyl (meth)acrylate, cyclododecyl (meth)acrylate, isobornyl (meth)acrylate, adamantyl (meth)acrylate, dicyclopentenyl (meth)acrylate, and dicyclopentanyl (meth)acrylate. Specific examples of the aromatic (meth)acrylate ester include phenyl (meth)acrylate, benzyl (meth)acrylate, phenoxymethyl (meth)acrylate, 2-phnenoxyethyl (meth)acrylate, and 3-phenoxypropyl (meth)acrylate.

Specific examples of the alkoxyalkyl (meth)acrylate ester include methoxyethyl (meth)acrylate, ethoxyethyl (meth)acrylate, n-propoxyethyl (meth)acrylate, n-butoxyethyl (meth)acrylate, methoxypropyl (meth)acrylate, ethoxypropyl (meth)acrylate, n-propoxypropyl (meth)acrylate, n-butoxypropyl (meth)acrylate, methoxybutyl (meth)acrylate, ethoxybutyl (meth)acrylate, n-propoxybutyl (meth)acrylate, and n-butoxybutyl (meth)acrylate.

In an alternative way, after polymerization of a vinyl ester compound such as vinyl acetate or vinyl propionate, the obtained polymer is saponified, to thereby yield a carboxyl group-containing polymer and including the structural unit (UB). Through saponification of a structural unit derived from a vinyl ester compound incorporated into the polymer, a carboxyl group-containing polymer and including a structural unit corresponding to vinyl alcohol can be formed. From the viewpoint of availability of raw material and for other reasons, the vinyl ester compound employed is preferably vinyl acetate. Such vinyl ester compounds may be used singly or in combination of two or more species.

In the case where the carboxyl group-containing polymer further includes, as the structural unit (UB), a structural unit differing from the structural unit (UB-1) (hereinafter may also be referred to as an “additional structural unit”), the additional structural unit content, with respect to all the structural units forming the carboxyl group-containing polymer, is preferably 1 mass % or more, more preferably 2 mass % or more, still more preferably 5 mass % or more. From the viewpoint of securing dispersibility of the active material(s) contained in the present composition, the relative amount of the additional structural unit, with respect to all the structural units forming the carboxyl group-containing polymer, is preferably 40 mass % or less, more preferably 35 mass % or less, still more preferably 30 mass % or less. The additional structural unit forming the carboxyl group-containing polymer may be a single species or two or more species.

In the carboxyl group-containing polymer, the relative amount of the structural unit (UB), with respect to all the structural units in the carboxyl group-containing polymer, is preferably 1 mass % to 50 mass %. The relative amount of the structural unit (UB), with respect to all the structural units in the carboxyl group-containing polymer, is more preferably 2 mass % or more, still more preferably 5 mass % or more, yet more preferably 10 mass % or more. The upper limit of the structural unit (UB) content is more preferably 45 mass % or less, still more preferably 40 mass % or less, with respect to all the structural units in the carboxyl group-containing polymer.

### (Salt of Carboxyl Group-Containing Polymer)

As the salt of the carboxyl group-containing polymer, a neutralization product in which at least a part of the carboxyl groups of the aforementioned carboxyl group-containing polymer have been neutralized is preferably used. The salt of the carboxyl group-containing polymer is preferably, among others, a neutralization product of the carboxyl group-containing polymer including the structural unit (UA). A preferable range of the structural unit (UA) content of the carboxyl group-containing polymer is the same as that described above.

Also, the salt of the carboxyl group-containing polymer may further include the structural unit (UB). From the viewpoints of achieving a well-balanced expression of applicability of the present composition, suppression of cracking of the electrode, and output characteristics and cycle characteristics of the lithium-sulfur secondary battery, it is preferable that the salt of the carboxyl group-containing polymer further includes the structural unit (UB-1), similar to the case of the aforementioned carboxyl group-containing polymer. Specific examples and preferred range of the structural unit (UB) and the structural unit (UB-1) included in the salt of the carboxyl group-containing polymer are the same as those described in relation to the carboxyl group-containing polymer.

In the salt of the carboxyl group-containing polymer, examples of the counter ion to “—COO⁻” (Rⁿ⁺) include lithium ion, sodium ion, potassium ion, magnesium ion, and calcium ion. Of these, lithium ion, sodium ion, and potassium ion are preferred, with lithium ion being more preferred. Use of a lithium salt of the carboxyl group-containing polymer as a binder is preferred, since the electrode resistance can be lowered, and output characteristics of the lithium-sulfur secondary battery can be improved.

The carboxyl group-containing polymer (or a salt thereof) may be a linear-chain polymer or a polymer having a cross-linking structure (i.e., a cross-linked polymer). When the carboxyl group-containing polymer (or a salt thereof) is a cross-linked polymer, achieving a higher effect of suppressing cracking of an electrode, yielding a lithium-sulfur secondary battery exhibiting excellent output characteristics, and enhancing the effect of improving the surface flatness of the electrode(s) can be attained, which is preferred.

No particular limitation is imposed on the method of producing the cross-linked polymer. Examples of the cross-linked polymer production method include the following methods (1) and (2):
(1) copolymerization of a monomer having a cross-linkable functional group (hereinafter may also be referred to as a “cross-linkable monomer”) and a monomer which differs from the cross-linkable monomer and which can be copolymerized with the cross-linkable monomer (hereinafter may also be referred to as a “non-cross-linkable monomer”), to thereby achieve cross-linking via the polymerization reaction; and
(2) synthesis of a polymer having a reactive functional group and optional cross-linking by adding a cross-linking agent.

Of these, method (1) is preferred, since the operation is simple, and the degree of cross-linking can be easily controlled.

As the cross-linkable monomer, an ethylenically unsaturated monomer having a cross-linkable functional group is preferably used. Specific examples of the cross-linkable monomer include a multi-functional polymerizable monomer having two or more ethylenically unsaturated groups, and a self-cross-linkable monomer having a self-cross-linkable functional group (e.g., a hydrolyzable silyl group). Specific examples of the multi-functional polymerizable monomer include a multi-functional (meth)acrylate compound, a multi-functional alkenyl compound, and a compound having both a (meth)acryloyl group and an alkenyl group. Among them, the ethylenically unsaturated monomer having a cross-linkable functional group is preferably a compound having an alkenyl group (a multi-functional alkenyl group or a compound having both a (meth)acryloyl group and an alkenyl group), with a multi-functional alkenyl compound being more preferred, from the viewpoint of easily forming a uniform cross-link structure.

Specific examples of the multi-functional alkenyl compound include multi-functional allyl ether compounds such as trimethylolpropane diallyl ether, trimethylolpropane triallyl ether, pentaerythritol diallyl ether, pentaerythritol triallyl ether, tetraallyloxyethane, and polyallysaccharose; multi-functional allyl compounds such as diallyl phthalate; and multi-functional vinyl compounds such as divinylbenzene. Of these, a multi-functional allyl ether compound having a plurality of allyl ether groups in the molecule thereof is particularly preferred as the multi-functional alkenyl compound. Specific examples of the (meth)acrylic acid compound having both a (meth)acryloyl group and an alkenyl group include alkenyl group-containing (meth)acrylic acid compounds such as allyl (meth)acrylate, isopropenyl (meth)acrylate, butenyl (meth)acrylate, pentenyl (meth)acrylate, and 2-(2-vinyloxyethoxy)ethyl (meth)acrylate.

Specific examples of the self-cross-linkable monomer include a vinyl monomer having a hydrolyzable silyl group. Examples of the vinyl monomer having a hydrolyzable silyl group include vinyl silanes such as vinyltrimethoxysilane, vinyltriethoxysilane, vinylmethyldimethoxysilane, and vinyldimethylmethoxysilane; silyl group-containing (meth)acrylate esters such as trimethoxysilylpropyl (meth)acrylate, triethoxysilylpropyl (meth)acrylate, and methyldimethoxysilylpropyl (meth)acrylate; trimethoxysilylpropyl vinyl ether; and vinyl trimethoxysilylundecanate.

As the non-cross-linkable monomer, an ethylenically unsaturated monomer having no cross-linkable functional group is preferably used. An example thereof is a mono-functional polymerizable monomer having one polymerizable unsaturated group (ethylenically unsaturated group). Specific examples of the non-cross-linkable monomer include compounds which are exemplified in relation to the monomer (A) and the monomer (B).

When the carboxyl group-containing polymer (or a salt thereof) includes a structural unit derived from a cross-linkable monomer, the amount of the structural unit derived from a cross-linkable monomer in the carboxyl group-containing polymer (or a salt thereof) is preferably 0.05 parts by mass to 5.0 parts by mass, with respect to the entire amount of the structural unit derived from a non-cross-linkable monomer (as 100 parts by mass). A relative amount of the structural unit derived from a cross-linkable monomer of 0.05 parts by mass or more is preferred, since the effect of suppressing cracking of the electrode can be enhanced. A relative amount of 5.0 parts by mass or less is also preferred, since cycle characteristics of the lithium-sulfur secondary battery can be secured.

From the above viewpoints, the amount of the structural unit derived from a cross-linkable monomer in the carboxyl group-containing polymer (or a salt thereof) is preferably 0.1 parts by mass or more, more preferably 0.2 parts by mass or more, still more preferably 0.3 parts by mass or more, with respect to the entire amount of the structural unit derived from a non-cross-linkable monomer (as 100 parts by mass). The upper limit of the amount of the structural unit derived from a cross-linkable monomer is preferably 4.0 parts by mass or less, more preferably 3.5 parts by mass or less, still more preferably 3.0 parts by mass or less, yet more preferably 2.5 parts by mass or less, with respect to the entire amount of the structural unit derived from a non-cross-linkable monomer (as 100 parts by mass). The cross-linkable monomer forming the carboxyl group-containing polymer (or a salt thereof) may be a single species or two or more species.

For the same reasons, the relative amount of the structural unit derived from a cross-linkable monomer in the carboxyl group-containing polymer (or a salt thereof) is preferably 0.1 mol % to 2.0 mol %, with respect to the entire amount of the structural unit derived from a non-cross-linkable monomer. The lower limit of the amount of the structural unit derived from a cross-linkable monomer is more preferably 0.2 mol % or more, still more preferably 0.5 mol % or more. The upper limit of the amount of the structural unit derived from a cross-linkable monomer is more preferably 1.5 mol % or less, still more preferably 1.2 mol % or less, yet more preferably 1.0 mol % or less.

When a cross-linked polymer is used as the carboxyl group-containing polymer (or a salt thereof), a commercial product thereof may be used. Examples of the commercial product include products (as tradenames) such as JUNLON (registered trademark) PW-120, JUNLON PW-121, and JUNLON PW-312S (products of TOAGOSEI Co., Ltd.); and Carbopol 934P NF, Carbopol 981, Carbopol Ultrez10, and Carbopol Ultrez30 (products of Lubrizol).

The carboxyl group-containing polymer (or a salt thereof) serving as the binder may be any of a carboxyl group-containing polymer and a salt thereof. Of these, a salt of the carboxyl group-containing polymer (i.e., a polymer prepared by neutralizing at least a part of the acid groups of the carboxyl group-containing polymer) is preferably used, from the viewpoints of enhancing the effect of improving the cycle characteristics of the lithium-sulfur secondary battery and further reducing the internal resistance of the electrode.

From the viewpoints of enhancing the effect of improving the cycle characteristics of the lithium-sulfur secondary battery and further reducing the internal resistance of the electrode, when a salt of the carboxyl group-containing polymer is used as the binder, the neutralization degree of the carboxyl group-containing polymer salt is preferably 70 mol % or more, more preferably 75 mol % or more, still more preferably 80 mol % or more, yet more preferably 85 mol % or more, further more preferably 90 mol % or more. The neutralization degree is determined on the basis of the ratio in intensity of a peak attributed to C═O group of a carboxylic acid salt to a peak attributed to C═O group of a corresponding carboxylic acid, the peak intensities being measured through an infrared (IR) spectrometry. The measurement method will be described in detail in the below-mentioned section of “Examples”.

When the carboxyl group-containing polymer (or a salt thereof) is a cross-linked polymer, the carboxyl group-containing polymer (or a salt thereof) may possibly be in the form of particles in a water medium. The carboxyl group-containing polymer (or a salt thereof) as the cross-linked polymer preferably a particle size of 0.1 μm to 7.0 μm as a volume-basis median diameter, wherein the particle size is determined in a water medium after neutralization to a neutralization degree of 80 mol % or more (hereinafter may also be referred to as a “water-swell particle size”). When the water-swell particle size of the carboxyl group-containing polymer (or a salt thereof) falls within the above range, applicability of the present composition, suppression of cracking of the electrode, and battery characteristics of the lithium-sulfur secondary battery can be improved in a well-balanced manner, which is preferred. From such viewpoints, the water-swell particle size of the carboxyl group-containing polymer (or a salt thereof) is more preferably 0.2 μm or more as a volume-basis median diameter, still more preferably 0.3 μm or more, yet more preferably 0.5 μm more. From the viewpoint of securing the applicability of the present composition and output characteristics of the lithium-sulfur secondary battery, the upper limit of the water-swell particle size of the carboxyl group-containing polymer (or a salt thereof) is more preferably 6.0 μm or less, still more preferably 5.0 μm or less, yet more preferably 3.0 μm or less. In determination of the water-swell particle size of a carboxyl group-containing polymer (or a salt thereof) which has received no neutralization or which has a neutralization degree less than 80 mol %, the polymer (or a salt thereof) is neutralized with an alkali metal hydroxide or the like to a neutralization degree to 80 mol % or more, and the product is dispersed in a water medium, before determination of water-swell particle size. The method of determining the water-swell particle size of the carboxyl group-containing polymer (or a salt thereof) will be described in detail in the below-mentioned section of “Examples”.

### [Method of Producing Carboxyl Group-Containing Polymer (or a Salt Thereof)]

No particular limitation is imposed on the polymerization method for producing the carboxyl group-containing polymer (or a salt thereof). Actually, the carboxyl group-containing polymer (or a salt thereof) may be produced by polymerizing monomers through, for example, a known polymerization technique such as solution polymerization, precipitation polymerization, suspension polymerization, or emulsion polymerization. Among these techniques, precipitation polymerization or suspension polymerization, (reverse-phase suspension polymerization) is preferably employed, from the viewpoint of productivity. Also, from the viewpoint of further enhancing a property such as binding performance, an inhomogeneous-system polymerization technique such as precipitation polymerization, suspension polymerization, or emulsion polymerization is preferred. In particular, precipitation polymerization is preferred.

Precipitation polymerization is a method for producing a polymer, in which polymerization reaction is carried out in a solvent that can dissolve an unsaturated monomer but cannot substantially dissolve the formed polymer. In precipitation polymerization, the size of polymer particles increases with the progress of polymerization via aggregation and growth of the particles. As a result, there is obtained a dispersion of polymer particles having a size of some micrometers to some tens of micrometers which are formed through secondary aggregation of the primary particles having a size of some tens of nanometers to some hundreds of nanometers aggregate. In order to suppress excessive aggregation of polymer particles for stabilization, a dispersion stabilizer is preferably used. A mode of precipitation polymerization in which secondary aggregation of polymer particles is suppressed by adding a dispersion stabilizer or another means is also called “dispersion polymerization”.

In precipitation polymerization, a solvent selected from water, various organic solvents, and other solvents may be used as the solvent used for polymerization, in consideration of the type and other properties of the monomers employed. From the viewpoint of forming a polymer having a long primary chain length, a solvent having a small chain transfer constant is preferably used.

Specific examples of the solvent for polymerization include aqueous solvents such as methanol, t-butyl alcohol, acetone, methyl ethyl ketone, acetonitrile, and tetrahydrofuran; and other solvents such as benzene, ethyl acetate, dichloroethane, n-hexane, cyclohexane, and n-heptane. These solvents for polymerization may be used singly or in combination of two or more species. Among them, the solvent for polymerization preferably includes at least one of methyl ethyl ketone and acetonitrile, from the viewpoints of suppression of coarse particles formation and deposition of the particles to a reactor, favorable polymerization stability, prevention of secondary aggregation of deposited polymer microparticles, production of a polymer having a great polymerization degree (primary chain length) and a small chain transfer constant, and easy operation in the below-mentioned in-process neutralization.

In order to proceed neutralization reaction in a stable manner at high speed in the in-process neutralization, a small amount of a high-polarity solvent is preferably added in advance to the solvent for polymerization. As such a high-polarity solvent, water and methanol are preferably used. The amount of the high-polarity solvent used is preferably 0.05 to 20 mass % with respect to the total mass of the solvent, more preferably 0.1 to 10 mass %.

When polymerization is performed through precipitation polymerization, the monomer concentration at the start of polymerization (hereinafter may also be referred to as an “initial monomer concentration”) is generally about 2 to about 40 mass %, preferably 5 to 40 mass %, from the viewpoint of producing a polymer having a longer primary chain length. Generally, as the monomer concentration at polymerization increases, the molecular weight of the formed polymer increases. That is, a polymer having a long primary chain length can be yielded.

As the dispersion stabilizer, a basic compound is preferably used. The basic compound may be any of an inorganic basic compound and an organic basic compound. Specific examples of the inorganic basic compound include alkali metal hydroxides such as lithium hydroxide, sodium hydroxide, and potassium hydroxide; and alkaline earth metal hydroxides such as calcium hydroxide and magnesium hydroxide. Specific examples of the organic basic compound include organic amine compounds such as monoethylamine, diethylamine, triethylamine, and tri-n-octylamine; and ammonia. Among them, organic amine compounds are preferred, from the viewpoints of polymerization stability and binding performance of an electrode binder.

The amount of the basic compound to be used may be appropriately set. For example, when the carboxyl group-containing polymer is produced from the monomer (A), the amount of the basic compound to be used, with respect to the entire amount of the monomer (A) involved in polymerization, is preferably 0.001 to 4.0 mol %. The amount of the basic compound to be used is more preferably 0.05 to 4.0 mol %, still more preferably 0.1 to 3.0 mol %. The amount of the basic compound to be used corresponds to the amount of the used basic compound with respect to the monomer (A) in terms of mole concentration, and does not mean the neutralization degree. That is, the valence of the basic compound is not taken into account.

As the polymerization initiator, a known polymerization initiator such as an azo-type compound, an organic peroxide, or an inorganic peroxide may be used. Specific examples of the azo-type compound include 2,2′-azobis(2,4-dimethylvaleronitrile), 2,2′-azobis(N-butyl-2-methylpropionamide), 2-(tert-butylazo)-2-cyanopropane, 2,2′-azobis(2,4,4-trimethylpentane), 2,2′-azobis(2-methylpropane), and dimethyl 2,2′-azobis(isobutyrate). The amount of the polymerization initiator to be used is generally 0.001 to 2 parts by mass with respect to the entire amount of the monomer(s) involved in polymerization as 100 parts by mass. From the viewpoints of consistently performing polymerization reaction and forming a polymer having a long primary chain length, the amount of the polymerization initiator is preferably 0.005 to 1 part by mass.

Polymerization temperature, which varies depending on the type, concentration, etc. of the monomer(s) used, is preferably 0 to 100° C., more preferably 20 to 80° C. The polymerization temperature may be constant or may vary in the course of polymerization reaction. Polymerization time is preferably 1 minute to 20 hours, more preferably 1 hour to 10 hours.

When the polymer dispersion obtained through the above polymerization is subjected to a drying process (e.g., reduced pressure treatment or heating treatment or both), and the solvent of the dispersion is distilled out, a target polymer can be yielded in the form of powder. For the purpose of removing unreacted monomer(s) (and a salt thereof), impurity matter originating from the initiator, and the like, before carrying out the drying process, a solid-liquid separation treatment (e.g., centrifugation or filtration) and a washing treatment with solvent are preferably conducted following the polymerization reaction. Examples of the solvent used in the washing treatment include water, methanol, and the same solvents employed as the solvent for polymerization.

In the case where a salt of the carboxyl group-containing polymer is used as the binder of the present composition, there may be employed a procedure which includes adding an alkaline compound to the polymer dispersion obtained through the above polymerization, to thereby neutralize the polymer (hereinafter may also be referred to as an “in-process neutralization”) and then carrying out the drying process so as to remove the solvent. In an alternative procedure, a powder of the polymer is obtained without carrying out in-process neutralization, and then an alkaline compound is added in preparation of the electrode mixture layer-forming composition, to thereby neutralize the polymer (hereinafter may also be referred to as a “post-neutralization”). In the case in which a salt of the carboxyl group-containing polymer is produced through precipitation polymerization, in-process neutralization is preferred among the above neutralization techniques, from the viewpoint of ease of disintegration of the secondary aggregate.

In the case in which the carboxyl group-containing polymer (or a salt thereof) is produced through dispersion polymerization, a dispersion in which polymer particles are dispersed in liquid is formed. No particular limitation is imposed on the method of isolating the polymer particles from the dispersion, and any known techniques may be employed. The target polymer particles can be recovered by subjecting the dispersion to a treatment, for example, removal of volatile components (e.g., liquid medium) through distillation, re-precipitation, vacuum drying, heat drying, filtration, centrifugation, or decantation.

The relative amount of the carboxyl group-containing polymer (or a salt thereof) in the present composition is, for example, 0.1 to 20 parts by mass with respect to the entire amount (as 100 parts by mass) of the components other than the medium contained in the present composition. When the relative amount of the carboxyl group-containing polymer (or a salt thereof) is 0.1 parts by mass or more, sufficient binding performance and dispersibility of active material can be secured. When the relative amount of the carboxyl group-containing polymer (or a salt thereof) is adjusted to 20 parts by mass or less, a rise in viscosity of the present composition can be suppressed, to thereby achieve suitable applicability to a current collector. In addition, a decrease in active material content due to an excessive amount of the carboxyl group-containing polymer (or a salt thereof) can be suppressed, whereby the output characteristics and the cycle characteristics of the lithium-sulfur secondary battery can be secured.

From the aforementioned viewpoints, the relative amount of the carboxyl group-containing polymer (or a salt thereof) in the present composition is preferably 0.5 parts by mass or more, more preferably 1 part by mass or more, with respect to the entire amount of the components other than the medium contained in the present composition. The upper limit of the relative amount of the carboxyl group-containing polymer (or a salt thereof) is preferably 15 parts by mass or less more preferably 12 parts by mass or less, still more preferably 10 parts by mass or less, with respect to the entire amount (as 100 parts by mass) of the components other than the medium contained in the present composition.

### <Sulfur-Based Active Material>

The present composition contains a sulfur-based active material as a positive electrode active material. Examples of the sulfur-based active material include elemental sulfur and a sulfur-based compound, and these members may be used in combination. Examples of the sulfur-based compound include lithium sulfide, an organic sulfur compound (e.g., a disulfide compound or an organic sulfur polymer), and a carbon-sulfur composite. Sulfur itself has no electrical conductivity. Thus, among these members, a carbon-sulfur composite is preferably used as a sulfur-based active material, from the viewpoint of providing electrical conductivity to achieve charge and discharge. In particular, a carbon-sulfur composite in which sulfur is supported by pores of a porous carbon powder (hereinafter may also be referred to as “sulfur-containing porous carbon”) is preferably used, since a higher effect of preventing elution of lithium polysulfide (Li₂Sₓ, x=4 to 8), which is a reaction intermediate generated in a positive electrode during discharge, can be attained, whereby loss of sulfur in the positive electrode can be suppressed.

The porous carbon powder forming the sulfur-containing porous carbon is a particulate carbon material having a large number of pores at least on the surface thereof. The porous carbon powder preferably has a mean pore size of 100 nm or smaller. Meanwhile, the pore of the porous carbon powder could be categorized into micro pore, meso pore, and macro pore, depending on the size of the pore diameter (pore size). The micro pore refers to a pore having a pore size of 2 nm or smaller; the meso pore a pore having a pore size of 2 to 50 nm; and the macro pore a pore having a pore size of 50 nm or larger. Notably, the mean pore size of the porous carbon powder is a value determined from a pore size distribution graph which is obtained from a nitrogen adsorption/desorption isothermal curve through an analysis technique fitted for the pore size. Specifically, the technique is a Barret-Joyner-Halenda (BJH) method in the case of macro pore (2 nm or larger) or meso pore, and a density functional theory (DFT) method in the case of micro pore (2 nm or smaller).

From the viewpoint of suppressing loss of sulfur in the positive electrode, the mean pore size of the porous carbon powder is preferably 80 nm or smaller, more preferably 50 nm or smaller. Also, from the viewpoints of enhancing the battery capacity of a lithium-sulfur secondary battery, which can be achieved by an increase in the amount of sulfur supported, and improving the cycle characteristics of the lithium-sulfur secondary battery, the mean pore size of the porous carbon powder is preferably 1 nm or larger, more preferably 2 nm or larger.

From the viewpoint of improving the battery capacity and cycle characteristics of the lithium-sulfur secondary battery, the BET specific surface area of the porous carbon powder is, for example, 500 m2/g or more, preferably 800 m2/g or more, more preferably 1,000 m2/g or more. The upper limit of the BET specific surface area of the porous carbon powder is preferably 3,000 m2/g or less, more preferably 2,500 m2/g or less.

Such a porous carbon powder can be produced by, for example, providing an organic compound serving as a raw material with a thermal hysteresis of 600° C. or higher. In addition to carbon, the porous carbon powder may further contain an atom such as nitrogen, oxygen, and hydrogen. Also, a commercial product of the porous carbon powder may be used. Examples of the commercial product (trade name) of the porous carbon powder include CNovel (registered trademark) MJ (4)₀₁₀, MJ (4)₀₃₀, and MH (products of Toyo Tanso Co., Ltd.).

The sulfur content of the sulfur-containing porous carbon (i.e., the ratio of the mass of sulfur to the total mass of sulfur-containing porous carbon) is preferably 35 to 95 mass %, from the viewpoint of producing a lithium-sulfur secondary battery exhibiting excellent battery characteristics. The sulfur content of the sulfur-containing porous carbon is more preferably 40 mass % or more, still more preferably 45 mass % or more, yet more preferably 50 mass % or more. From the viewpoint of ease of production, the upper limit of the sulfur content is more preferably 90 mass % or less.

The sulfur-containing porous carbon may be produced from porous carbon powder and sulfur through a known method. In one possible process, a porous carbon powder and sulfur are mixed together, and the mixture is heated at a temperature equal to or higher than the melting point of sulfur (e.g., 110° C. or higher), to thereby melt sulfur. Pores of the porous carbon powder are impregnated with sulfur via a capillary phenomenon. After impregnation of pores of the porous carbon powder with sulfur, remaining sulfur may be removed through further heating (e.g., heating at 250° C. or higher).

The relative amount of the sulfur-based active material in the present composition is, for example, 70 to 99.8 parts by mass, with respect to the entire amount (as 100 parts by mass) of the components other than the medium contained in the present composition. When the sulfur-based active material content is 70 parts by mass or more, the sulfur content of the electrode can be sufficiently enhanced, and suitable battery characteristics of the produced lithium-sulfur secondary battery can be achieved. Also, when the sulfur-based active material content is adjusted to 99.8 parts by mass or less, binding performance and dispersibility of the sulfur-based active material, which would be attained by other added components, as well as electrical conductivity of the electrode can be secured. From such viewpoints, the sulfur-based active material of the present composition is preferably 75 parts by mass or more, more preferably 80 parts by mass or more, with respect to the entire amount of the components other than the medium contained in the present composition. The upper limit of the sulfur-based active material content is preferably 99.5 parts by mass or less, with respect to the entire amount (as 100 parts by mass) of the components other than the medium contained in the present composition. The above sulfur-based active materials may be used singly or in combination of two or more species (i.e., a mixture or a compound).

### <Thickening Agent>

To the present composition, a thickening agent is further added. According to the present composition which contains a carboxyl group-containing polymer (or a salt thereof) serving as a binder, a sulfur-based active material, and a thickening agent, aggregation of the sulfur-based active material can be suppressed, whereby the dispersibility of the sulfur-based active material in the formed electrode mixture layer can be improved. When the dispersibility of the sulfur-based active material increases, suitable surface flatness of the electrode can be achieved.

Examples of the thickening agent include a cellulose-based water-soluble polymer, a substituted product of a cellulose-based water-soluble polymer in which at least a part of hydroxy groups are substituted by a carboxymethyl group or a salt thereof (hereinafter may also be referred to as a “carboxymethyl group-substituted product or a salt thereof”), alginic acid or a salt thereof, oxidized starch, phosphorylated starch, casein, and starch. Among them, the thickening agent incorporated into the present composition is preferably a cellulose-based water-soluble polymer, or a carboxymethyl group-substituted product or a salt thereof, with a carboxymethyl group-substituted product or a salt thereof being more preferred.

Specific examples of the cellulose-based water-soluble polymer include alkylcelluloses such as methylcellulose, methylethylcellulose, ethylcellulose, and microcrystalline cellulose; and hydroxyalkylcelluloses such as hydroxyethylcellulose, hydroxybutylmethylcellulose, hydroxypropylcellulose, hydroxypropylmethylcellulose, hydroxyethylmethylcellulose, hydroxypropylmethylcellulose stearoxy ether, carboxymethylhydroxyethylcellulose, alkylhydroxyethylcellulose, and nonoxynylhydroxyethylcellulose.

Specific examples of the cellulose-based water-soluble polymer that serve as a base of the carboxymethyl group-substituted product or a salt thereof include those as described in relation to the aforementioned cellulose-based water-soluble polymer. Examples of the salt of the substituted product include a sodium salt thereof and a potassium salt thereof, with a sodium salt thereof being preferred. Among them, the carboxymethyl group-substituted product or a salt thereof is preferably sodium carboxymethylcellulose, from the viewpoint of dispersibility of the sulfur-based active material.

The relative amount of the thickening agent contained in the present composition is, for example, 0.2 to 20 parts by mass, with respect to the entire amount (as 100 parts by mass) of the components other than the medium contained in the present composition. When the thickening agent content is 0.2 parts by mass or more, sufficient dispersibility of the sulfur-based active material can be secured. When the thickening agent content is adjusted to 20 parts by mass or less, a rise in viscosity of the present composition can be suppressed, to thereby achieve suitable applicability onto a current collector. From such viewpoints, the relative amount of the thickening agent contained in the present composition is preferably 0.5 parts by mass or more, more preferably 1 part by mass or more, with respect to the entire amount of the components other than the medium contained in the present composition. The upper limit of the thickening agent content is preferably 15 parts by mass or less, more preferably 10 parts by mass or less, with respect to the entire amount (as 100 parts by mass) of the components other than the medium contained in the present composition. These thickening agents may be used singly or in combination of two or more species.

### <Water>

The present composition contains water as a medium. From the viewpoint of achieve suitable applicatability to the surface of a current collector, the present composition is preferably a slurry containing a carboxyl group-containing polymer (or a salt thereof) and a sulfur-based active material.

When the present composition is provided in the form of slurry, the relative amount of the medium contained in the present composition is, for example, 25 to 90 mass %, preferably 40 to 85 mass %, with respect to the entire amount of the present composition. Alternatively, the present composition may be in the form of wet powder, which can form an electrode mixture layer on the surface of a current collector through pressing. When the present composition is provided in the form of wet powder, the relative amount of the medium contained in the present composition is, for example, 3 to 40 mass %, preferably 10 to 30 mass %, with respect to the entire amount of the present composition.

### <Additional Components>

The present composition may further contain a component other than the carboxyl group-containing polymer (or a salt thereof) serving as a binder, the thickening agent, the sulfur-based active material, and water (hereinafter may also be referred to as an “additional component”). Examples of the additional component include a conducting aid and a medium other than water (hereinafter may also be referred to as an “additional medium”).

### [Conducting Aid]

The conducting aid is used for the purpose such as enhancing the electrical conductivity of an electrode. Examples of the conducting aid include carbonaceous materials such as carbon black, carbon nanotube (CNT), carbon nanohorn, carbon nanofiber, carbon nanofilament, carbon fibril, vapor grown carbon fiber, and graphite micropowder. Among them, from the viewpoint of provision of high electrical conductivity, carbon black, carbon nanotube, and carbon nanofiber are preferred. As carbon black, ketjen black or acetylene black is preferred. Examples of the CNT include single-wall carbon nanotube (SWCNT) and multi-wall carbon nanotube (MWCNT). Examples of available MWCNT products include carbon nanotube “VGCF-H” (product of Showa Denko K. K.). Notably, the conducting aids may be used singly or in combination of two or more species.

From the viewpoint of achieving satisfactory electrical conductivity with energy density, the relative amount of the conducting aid in the present composition may be adjusted to, for example, 0.2 to 20 parts by mass, with respect to the entire amount (as 100 parts by mass) of the components other than the medium contained in the present composition. The conducting aid content is preferably 0.5 to 17 parts by mass, more preferably 1 to 15 parts by mass.

### [Additional Medium]

The additional medium is used for modifying the property, drying performance, etc. of the present composition. The additional medium is preferably an aqueous organic solvent, and examples of the aqueous organic solvent include a lower alcohol such as methanol or ethanol; a carbonate such as ethylene carbonate; a ketone such as acetone; and a cyclic ether such as tetrahydrofuran. When a solvent mixture of water and the additional solvent is used as a medium, the water content of the solvent mixture is, for example, 50 mass % or more, preferably 70 mass % or more, still more preferably 80 mass % or more.

So long as the effects of the present disclosure are not impaired, the present composition may contain a component other than the conducting aid and the medium, as an additional component. Examples of the component include an additional binder component such as acrylic latex, and poly(vinylidene fluoride)-base latex.

The present composition may be prepared by mixing the carboxyl group-containing polymer (or a salt thereof) serving as a binder, the sulfur-based active material, the thickening agent, water, and an additional component or components employed in accordance with needs. No particular limitation is imposed on the method of mixing the components, and any known mixing method may be employed. In particular, there is preferred a dispersion kneading method, in which powder components including the active material, the conducting aid, etc. are dry-blended, and the thus-prepared mixture of the active material, the conducting aid, etc. is mixed with a separately prepared aqueous dispersion of the carboxyl group-containing polymer (or a salt thereof) and an aqueous solution of the thickening agent.

When the present composition is provided in the form of slurry, a known mixer such as a planetary mixer, a thin film spin system mixer, or a planetary centrifugal mixer may be used as a mixing apparatus. Among these mixing means, a thin film spin system mixer is preferably employed, from the viewpoint of achieving a favorable dispersion state within a short period of time. When the present composition is prepared in the form of slurry, the viscosity of the slurry is, for example, 500 to 100,000 mPa·s as determined by means of a type B viscometer at 25° C. and a rotor speed of 60 rpm, preferably 1,000 to 50,000 mPa·s.

Meanwhile, when the present composition is prepared in the form of wet powder, the composition is preferably kneaded into a uniform state (i.e., involving no variation in concentration) by means of a Henschel mixer, a blender, a planetary mixer, a twin screw kneader, or the like.

### <<Electrode for Lithium-Sulfur Secondary Battery>>

The lithium-sulfur secondary battery electrode of the present disclosure (hereinafter may also be referred to “the present electrode”) is employed as a positive electrode of the lithium-sulfur secondary battery. The electrode has a current collector (i.e., a positive electrode current collector) and an electrode mixture layer (i.e., a positive electrode mixture layer). Examples of the material of the positive electrode current collector include a foil of a metal such as aluminum or stainless steel. From the viewpoints of corrosion resistance and mechanical characteristics, an aluminum foil is preferably used as the material of the positive electrode current collector.

The positive electrode mixture layer is a thin-film layer formed from the present composition and is disposed on the surface of the current collector such that the layer joins to the current collector. In one preferred procedure of forming the positive electrode mixture layer, the slurry-form present composition is applied onto the surface of the current collector, and water is removed by drying. No particular limitation is imposed on the method of applying the present composition onto the surface of the current collector, and any known application method may be employed. Examples of such an application method include doctor blading, dipping, roller coating, comma coating, curtain coating, gravure coating, and extrusion. The dry removal treatment may be conducted through any known method such as hot air blowing, reduced pressure treatment, (far) infrared radiation, or microwave radiation.

The amount of the present composition applied to the surface of the current collector may appropriately be tuned in accordance with the viscosity of the present composition, the thickness of the target electrode mixture layer. The amount of the present composition to be applied is, for example, 0.1 to 25 mg/cm² as reduced to sulfur contained in the present composition, preferably 0.2 to 22 mg/cm².

After drying, the thus-formed positive electrode mixture layer may be subjected to a compression treatment such as metal mold pressing or roller pressing. Through the compression treatment, the active material is caused to be closely bonded to the binder, whereby the strength of the positive electrode mixture layer and close adhesion to the current collector can be enhanced. Through the compression treatment, the thickness of the positive electrode mixture layer can be regulated to, for example, about 30 to about 80% the initial thickness. The thickness of the positive electrode mixture layer after compression is generally about 4 to about 200 μm.

### <<Lithium-Sulfur Secondary Battery>>

The lithium-sulfur secondary battery of the present disclosure (hereinafter may also be referred to as “the present secondary battery”) has the aforementioned lithium-sulfur secondary battery electrode of the present disclosure. More specifically, the present secondary battery has a positive electrode provided with an electrode mixture layer formed from the present composition, a negative electrode, and a separator disposed between the positive electrode and the negative electrode. The space between the positive electrode and the negative electrode is filled with an electrolyte, and lithium ions move between the positive electrode and the negative electrode by the mediation of the electrolyte, to thereby evoke charge and discharge.

Similar to the positive electrode, the negative electrode has a current collector (i.e., a negative electrode current collector), an electrode mixture layer containing a negative electrode active material (i.e., (a negative electrode mixture layer). No particular limitation is imposed on the material forming the negative electrode, and the material to be used may be appropriately selected from any materials known to serve as a material of a lithium-sulfur secondary battery electrode. For example, a metal foil such as a copper foil or a lithium foil may be used as a negative electrode current collector. No particular limitation is imposed on the negative electrode active material, so long as the material contains lithium. Examples of the negative electrode active material include metallic lithium, lithium alloys (e.g., silicon-lithium alloy and aluminum-lithium alloy), lithium oxide, and lithium sulfide. Similar to the positive electrode mixture layer, the negative electrode mixture layer may be formed by mixing the negative electrode active material with a conducting aid and a binder, to form a slurry, and applying the slurry onto a surface of the current collector.

The separator may be formed from a polymer porous membrane (e.g., olefin porous membrane), non-woven fabric, or the like. As the electrolyte, an electrolytic solution prepared by dissolving an electrolyte salt in a solvent may be used. A known material may be used as the electrolyte salt, and examples of the salt include LiPF₆, LiClO₄, LiBF₄, lithium bis(fluorosulfonyl)imide (LiFSI), lithium bis(trifluoromethanesulfonyl)imide (LiTFSI), LiAsF₆, LiCF(CF₃)₅, LiCF₂(CF₃)₄, LiCF₃(CF₃)₃, LiCF₄(CF₃)₂, LiCF₃(CF₃), LiCF₃(C2F₅)₃, LiCF₃SO₃, and LiN(CF₃SO₂)₂. Examples of the solvent which may be used include organic solvents such as ethylene carbonate, propylene carbonate, dimethyl carbonate, diethyl carbonate, methyl ethyl carbonate, fluoroethylene carbonate, vinylene carbonate, dimethoxyethane, tetrahydrofuran, dioxolane, and 1,1,2,2-tetrafluoro-3-(1,1,2,2-tetrafluoroethoxy)-propane. These solvents may be used singly or in combination of two or more species. In the present secondary battery, a solid electrolyte may also be used as the electrolyte.

No particular limitation is imposed on the form of the present secondary battery, and examples of the battery form include button, coin, cylinder, square, sheet, and laminate. In addition, the present secondary battery finds various uses. Specific examples include a power source for applications, for example, mobile devices such as mobile phones, personal computers, smart phones, game machines, and wearable terminals; mobile bodies such as electric vehicles, hybrid vehicles, robots, and drones; and electronic/electric appliances such as digital cameras, video cameras, music players, electric power tools, and domestic electric products.

### Examples

The disclosure will be described more specifically by way of example, which should not be construed as limiting the disclosure thereto. Unless otherwise specified, the units “part(s)” and “%” refer to “part(s) by mass” and “mass %,” respectively.

### 1. Production of Carboxyl Group-Containing Polymer (or a Salt Thereof)

### Production Example 1: Production of a Salt of Carboxyl Group-Containing Polymer Salt R-1

In polymerization, a reactor equipped with an agitation paddle, a thermometer, a reflux condenser, and a nitrogen-feeding pipe was employed. To the reactor, there were added acetonitrile (567 parts), acrylic acid (hereinafter also abbreviated as “AA”) (80.0 parts), methyl acrylate (solubility in water: 6 g/100 g-water, hereinafter abbreviated as “MA”) (20.0 parts), trimethylolpropane diallyl ether (“NEOALLYL T-20,” product of OSAKA SODA Co., Ltd.) (0.9 parts), and triethylamine. The amount of triethylamine was adjusted to 1.0 mol % with respect to AA. The atmosphere of the reactor was thoroughly purged with nitrogen, and the reactor was heated to 55° C. After achievement of a stable internal temperature of 55° C., 2,2′-azobis(2,4-dimethylvaleronitrile) (“V-65,” product of FIJIFILM Wako Pure Chemical Corporation) (0.040 parts) serving as a polymerization initiator was added to the reactor. Since the reaction mixture was clouded, that point of time was regarded as the start of polymerization. The monomer concentration at the start of polymerization (i.e., an initial monomer concentration) was calculated as 15.0%.

Twelve hours after the start of polymerization, the reaction mixture was cooled. When the internal temperature was lowered to 25° C., a powder of lithium hydroxide monohydrate (hereinafter referred to as “LiOH·H₂O”) (41.9 parts) was added thereto (in-step neutralization). After addition of the lithium salt, the mixture was continuously agitated for 12 hours at room temperature, to thereby yield a slurry-form polymerization reaction mixture in which particles of a salt of a carboxyl group-containing polymer salt R-1 (Li salt, neutralization degree of 90 mol %) were dispersed in a medium. Percent reactivity of AA and that of MA after 12 hours from the start of polymerization were calculated as 97.6% and 96.9%, respectively.

The thus-obtained polymerization reaction mixture was subjected to centrifugation, to thereby precipitate polymer particles, and then the supernatant was removed. Subsequently, the sediment was re-dispersed in acetonitrile in the same amount (by mass) as that of the polymerization reaction mixture. A washing operation including precipitating polymer particles through centrifugation and removing the supernatant was repeated twice. Thus, the sediment was recovered and dried at 80° C. for 3 hours under reduced pressure, to thereby remove the volatile matter, whereby a powder of a carboxyl group-containing polymer salt R-1 (i.e., a hydrophilic polymer) was yielded. Since the carboxyl group-containing polymer salt R-1 had hygroscopicity, the polymer salt was stored and sealed in a container having water vapor barrier property. An IR spectrum of the powder of the carboxyl group-containing polymer salt R-1 was measured. The neutralization degree was determined on the basis of the ratio in intensity of a peak attributed to C═O group (Li carbonate) to a peak attributed to C═O group (carboxylic acid). As a result, the neutralization degree was found to be 90.0 mol %, which was the same as the corresponding value calculated from the amounts of starting materials. Also, the particle size of the carboxyl group-containing polymer salt R-1 in a water medium (i.e., a water-swell particle size) was determined through the below-described procedure. The particle size was 1.4μ m.

### <Method of Determining Particle Size in a Water Medium (i.e., a Water-Swell Particle Size)>

A powder of a carboxyl group-containing polymer salt (0.25 g) and ion exchange water (49.75 g) were weighed and put into a container (100 cc), and the container was set in a planetary centrifugal mixer (Awatori-Rentaro AR-250, product of Thinky Corporation). Then, agitation (conditions: rotation speed of 2,000 rpm/revolution speed of 800 rpm for 7 minutes) and further defoaming (conditions: rotation speed of 2,200 rpm/revolution speed of 60 rpm for 1 minute) were conducted, to thereby prepare a hydrogel in which the carboxyl group-containing polymer salt was swollen with water. When the carboxyl group-containing polymer salt had a neutralization degree of 80 mol % or more, the above procedure as is was conducted. When the carboxyl group-containing polymer (salt) had a neutralization degree less than 80 mol %, the polymer salt was neutralized with an alkali metal hydroxide or the like to a neutralization degree of 80 mol % or more, and the product was dispersed in water, before determination of the particle size.

Thereafter, the particle size distribution of the hydrogel was determined by means of a laser diffraction/scattering particle size analyzer (Microtrac MT-3300EXII, product of MicrotracBEL Corp.) with ion exchange water as a dispersion medium. Specifically, a specific amount of the hydrogel so as to gain an appropriate scattering light intensity was put into a circulating dispersion medium in an amount excessive to the amount of the hydrogel. Several minutes after, the shape of the measured particle size distribution stabilized. As soon as it was confirmed that the shape of the particle size distribution was stable, measurement was started. As a result, the volume-basis median diameter (D50) and the particle size distribution represented by a ratio of “(volume-basis mean particle size)/(number-basis mean particle size)” were obtained as representative values in terms of the particle size. The thus-determined volume-basis median diameter (D50) was employed as a water-swell particle size.

### Production Examples 2 to 14: Production of Carboxyl Group-Containing Polymer Salts R-2 to R-14

The procedure of Production Example 1 was repeated, except that the amounts of the raw materials were changed to the values shown in Table 1, to thereby yield polymerization reaction mixtures containing carboxyl group-containing polymer salts R-2 to R-14, respectively. All the polymerization reaction mixtures exhibited a monomer (A) reactivity and a monomer (B) reactivity of 90% or higher, 12 hours after the start of polymerization. Table 1 shows the results along with the solubility of monomer (B) in 100 g of water at 20° C. (i.e., water solubility).

Subsequently, each polymerization reaction mixture was subjected to the same procedure as conducted in Production Example 1, to thereby yield a powder of each of the carboxyl group-containing polymer salts R-2 to R-14. The polymer salts were stored and sealed in a container having water vapor barrier property. Similar to Production Example 1, the water-swell particle size of each of the obtained carboxyl group-containing polymer salts was determined. Table 1 shows the results.

### Production Example 15: Production of Carboxyl Group-Containing Polymer Salt R-15

In polymerization, a reactor equipped with an agitation paddle, a thermometer, a reflux condenser, and a nitrogen-feeding pipe was employed.

Methyl acrylate (hereinafter may also be abbreviated as “MA”) (8 parts) and vinyl acetate (hereinafter may also be abbreviated as “VAc”) (12 parts) were mixed, and dimethyl 2,2′-azobis(isobutyrate) (V-601, product of FUJIFILM Wako Pure Chemical Corporation) (0.67 parts) was dissolved in the mixture, to thereby prepare a monomer solution.

To the reactor, water (410 parts), sodium sulfate anhydrate (10 parts), partially saponified poly(vinyl alcohol) (“PVA-217,” product of Kuraray Co., Ltd., saponification degree: 88%) (1 part), and the above-prepared monomer solution (20.67 parts) were added. The atmosphere of the reactor was thoroughly purged with nitrogen, and the reactor was heated to 60° C. (inside temperature). After achievement of a stable internal temperature of 60° C., a solution mixture of MA (32 parts) and VAc (48 parts) was added dropwise to the reactor through a dropping funnel over 4 hours. One hour after completion of dropwise addition, cooling of the reaction mixture was started, to thereby terminate reaction. As a result, a polymerization reaction mixture containing a copolymer of MA and VAc was yielded. At that timing, reactivity of MA and that of VAc were calculated as 97.6% and 81.9%, respectively.

The thus-obtained polymerization reaction mixture was heated to 50° C. (outside temperature), and the solvent was removed under reduced pressure, to thereby remove remaining monomers. Thereafter, methanol (500 parts) and LiOH·H₂O (38.8 parts) were added in amounts with respect to those of starting monomers (MA and VAc) (100 parts in total). Saponification was performed at 50° C. (outside temperature) for 3 hours, to thereby yield a reaction mixture containing a saponified copolymer of MA and VAc.

The reaction mixture containing the saponified copolymer was subjected to re-precipitation in acetone, and the precipitates were recovered through filtration. The solid was dried at 80° C. for 12 hours for removing volatile components, to thereby yield a saponified copolymer of MA and VAc. On the basis of the aforementioned percent polymerization of MA and that of VAc, the yielded saponification product was identified to be a lithium salt of a non-cross-linked polymer having an “acrylic acid unit content of 57 mass %” and a “vinyl alcohol unit content of 43 mass %” in which polymer a part of carboxyl groups were neutralized (i.e., carboxyl group-containing polymer salt R-15).

Since the carboxyl group-containing polymer salt R-15 had hygroscopicity, the polymer salt was stored and sealed in a container having water vapor barrier property. An IR spectrum of the powder of the carboxyl group-containing polymer salt R-15 was measured. The neutralization degree was determined on the basis of the ratio in intensity of a peak attributed to C═O group (Li carbonate) to a peak attributed to C═O group (carboxylic acid). As a result, the neutralization degree was found to be 90.0 mol %, which was the same as the corresponding value calculated from the amounts of starting materials.

TABLE 1

| | | | | Production Example No. | | | | | |
|---|---|---|---|---|---|---|---|---|---|
| | | | | Production | Production | Production | Production | Production | Production |
| | | | | Example 1 | Example 2 | Example 3 | Example 4 | Example 5 | Example 6 |
| Carboxyl group-containing polymer (or a salt thereof) | | | | R-1 | R-2 | R-3 | R-4 | R-5 | R-6 |
| Preparation | monomer (A) | AA | water solubility: miscible | 80.0 | 80.0 | 80.0 | 80.0 | 80.0 | 80.0 |
| of materials | monomer (B) | MA | water solubility: | 20.0 | | | | | |
| [part(s)] | | | 6 [g/100 g-water] | | | | | | |
| | | EA | water solubility: | | 20.0 | | | | |
| | | | 1.5 [g/100 g-water] | | | | | | |
| | | BA | water solubility: | | | 20.0 | | | |
| | | | 0.2 [g/100 g-water] | | | | | | |
| | | PEA | water solubility: | | | | 20.0 | | |
| | | | 0.38 [g/100 g-water] | | | | | | |
| | | HEA | water solubility: miscible | | | | | 20.0 | |
| | | HEAA | water solubility: soluble | | | | | | 20.0 |
| | cross-linkable | T-20 [part(s)] | | 0.9 | 0.9 | 0.9 | 0.9 | 0.9 | 0.9 |
| | monomer | amount [mol %] | | 0.31% | 0.32% | 0.33% | 0.34% | 0.33% | 0.33% |
| | basic compound | TEA [mol %] | | 1.0 | 1.0 | 1.0 | 1.0 | 1.0 | 1.0 |
| | solvent for | AcN | | 567 | 567 | 567 | 567 | 567 | 567 |
| | polymerization | | | | | | | | |
| | polymerization | V-65 | | 0.040 | 0.040 | 0.040 | 0.040 | 0.040 | 0.040 |
| | initiator | | | | | | | | |

| | | | | | | | |
|---|---|---|---|---|---|---|---|
| in-process | LiOH•H₂O | 41.9 | 41.9 | 41.9 | 41.9 | 41.9 | 41.9 |
| neutralization | Na₂CO₃ | | | | | | |
| | K₂CO₃ | | | | | | |

| Initial monomer concentration [wt %] | | 15% | 15% | 15% | 15% | 15% | 15% |
|---|---|---|---|---|---|---|---|
| Neutralization salt | type | Li | Li | Li | Li | Li | Li |
| | neutralization degree [mol %] | 90.0% | 90.0% | 90.0% | 90.0% | 90.0% | 90.0% |

| | | | | | | |
|---|---|---|---|---|---|---|
| Water-swell particle size [μm] | 1.4 | 1.4 | 1.3 | 1.3 | 0.9 | 1.1 |

| | | | | Production Example No. | | | | |
|---|---|---|---|---|---|---|---|---|
| | | | | Production | Production | Production | Production | Production |
| | | | | Example 7 | Example 8 | Example 9 | Example 10 | Example 11 |
| Carboxyl group-containing polymer (or a salt thereof) | | | | R-7 | R-8 | R-9 | R-10 | R-11 |
| Preparation | monomer (A) | AA | water solubility: miscible | 100.0 | 100.0 | 97.0 | 90.0 | 60.0 |
| of materials | monomer (B) | MA | water solubility: | | | | | |
| [part(s)] | | | 6 [g/100 g-water] | | | | | |
| | | EA | water solubility: | | | | | |
| | | | 1.5 [g/100 g-water] | | | | | |
| | | BA | water solubility: | | | 3.0 | 10.0 | 40.0 |
| | | | 0.2 [g/100 g-water] | | | | | |
| | | PEA | water solubility: | | | | | |
| | | | 0.38 [g/100 g-water] | | | | | |
| | | HEA | water solubility: miscible | | | | | |
| | | HEAA | water solubility: soluble | | | | | |
| | cross-linkable | T-20 [part(s)] | | 0.9 | | 0.9 | 0.9 | 0.9 |
| | monomer | amount [mol %] | | 0.30% | 0.00% | 0.31% | 0.32% | 0.37% |
| | basic compound | TEA [mol %] | | 1.0 | 1.0 | 1.0 | 1.0 | 1.0 |
| | solvent for | AcN | | 567 | 567 | 567 | 567 | 567 |
| | polymerization | | | | | | | |
| | polymerization | V-65 | | 0.040 | 0.040 | 0.040 | 0.040 | 0.040 |
| | initiator | | | | | | | |

| | | | | | | |
|---|---|---|---|---|---|---|
| in-process | LiOH•H₂O | 52.4 | 52.4 | 50.8 | 47.2 | 31.4 |
| neutralization | Na₂CO₃ | | | | | |
| | K₂CO₃ | | | | | |

| Initial monomer concentration [wt %] | | 15% | 15% | 15% | 15% | 15% |
|---|---|---|---|---|---|---|
| Neutralization salt | type | Li | Li | Li | Li | Li |
| | neutralization degree [mol %] | 90.0% | 90.0% | 90.0% | 90.0% | 90.0% |

| | | | | | |
|---|---|---|---|---|---|
| Water-swell particle size [μm] | 1.7 | dissolution | 1.7 | 1.5 | 1.0 |

| | | | | Production Example No. | | |
|---|---|---|---|---|---|---|
| | | | | Production | Production | Production |
| | | | | Example 12 | Example 13 | Example 14 |
| Carboxyl group-containing polymer (or a salt thereof) | | | | R-12 | R-13 | R-14 |
| Preparation | monomer (A) | AA | water solubility: miscible | 80.0 | 80.0 | 80.0 |
| of materials | monomer (B) | MA | water solubility: | | | |
| [part(s)] | | | 6 [g/100 g-water] | | | |
| | | EA | water solubility: | | | |
| | | | 1.5 [g/100 g-water] | | | |
| | | BA | water solubility: | 20.0 | 20.0 | 20.0 |
| | | | 0.2 [g/100 g-water] | | | |
| | | PEA | water solubility: | | | |
| | | | 0.38 [g/100 g-water] | | | |
| | | HEA | water solubility: miscible | | | |
| | | HEAA | water solubility: soluble | | | |

| cross-linkable | T-20 [part(s)] | 0.9 | 0.9 | 0.9 |
|---|---|---|---|---|
| monomer | amount [mol %] | 0.33% | 0.33% | 0.33% |
| basic compound | TEA [mol %] | 1.0 | 1.0 | 1.0 |
| solvent for | AcN | 567 | 567 | 567 |
| polymerization | | | | |
| polymerization | V-65 | 0.040 | 0.040 | 0.040 |
| initiator | | | | |

| | | | | |
|---|---|---|---|---|
| in-process | LiOH•H₂O | 32.6 | | |
| neutralization | Na₂CO₃ | | 53.5 | |
| | K₂CO₃ | | | 69.4 |

| Initial monomer concentration [wt %] | | 15% | 15% | 15% |
|---|---|---|---|---|
| Neutralization salt | type | Li | Na | K |

| | | | |
|---|---|---|---|
| neutralization degree [mol %] | 70.0% | 90.0% | 90.0% |

| | | | |
|---|---|---|---|
| Water-swell particle size [μm] | 1.4 | 1.3 | 1.3 |

Details of the compounds shown in Table 1 are as follows.
AA: acrylic acid
MA: methyl acrylate
EA: ethyl acrylate
BA: n-butyl acrylate
PEA: phenoxyethyl acrylate (“Viscoat #192,” product of Osaka Organic Chemical Industry Ltd.)
HEA: 2-hydroxyethyl acrylate
HEAA: 2-hydroxyethylacrylamide
T-20: trimethylolpropane diallyl ether (“NEOALLYL T-20,” product of OSAKA SODA Co., Ltd.)
TEA: triethylamine
AcN: acetonitrile
V-65: 2,2′-azobis(2,4-dimethylvaleronitrile) (product of FIJIFILM Wako Pure Chemical Corporation)
LiOH·H₂O: lithium hydroxide monohydrate
Na₂CO₃: sodium carbonate
K2CO₃: potassium carbonate

### 2. Production of Electrode Mixture Layer-Forming Composition and Cell for Evaluation, and Evaluation Thereof

### Example 1

### (1) Preparation of Sulfur-Based Active Material

A commercial sulfur powder (colloidal sulfur powder, product of Sigma Aldrich) and mesoporous carbon powder (Cnovel M H, product of Toyo Tanso Co., Ltd., mean pore size: about 5 nm) were put in a sealable container at a mass ratio of 65/35 and mixed together. The container was closed and heated at 155° C. for 6 hours, to thereby yield a carbon-sulfur composite in which pores of the mesoporous carbon powder were filled with sulfur (i.e., a sulfur-containing porous carbon).

### (2) Preparation of Electrode Mixture Layer-Forming Composition

The sulfur-containing porous carbon prepared in (1) above (0.90 g) and a conducting aid (acetylene black, product of Denka) (0.05 g) were placed in a mortar and mixed together for about 10 minutes, to thereby form a mixture (hereinafter referred to as a “mixture Mx”). Subsequently, the carboxyl group-containing polymer salt R-1 (0.02 g) serving as a binder was dispersed in water (0.63 g), to thereby prepare a dispersion of the carboxyl group-containing polymer lithium salt in water. Separately, carboxymethylcellulose sodium (CMC, Cellogen, product of DKS Co., Ltd.) (0.03 g) serving as a thickening agent was dissolved in water (2.07 g), to thereby prepare aqueous CMC solution.

To the mixture Mx, the aqueous dispersion of the carboxyl group-containing polymer lithium salt and the aqueous CMC solution were added, and water (0.3 g) was further added so as to attain an appropriate viscosity. The resultant mixture was kneaded by means of Awatori-Rentaro AR-250 (product of Thinky Corporation, rotation: 2,000 rpm, kneading time: 30 minutes), to thereby prepare an electrode slurry serving as an electrode mixture layer-forming composition. The electrode slurry was prepared so that the sulfur-containing porous carbon content, a conducting aid content, a binder content, and a CMC content were adjusted to 90 mass %, 5 mass %, 2 mass %, and 3 mass %, respectively.

### (3) Production of Positive Electrode Plate

The electrode slurry obtained in (2) above was applied onto a positive electrode current collector made of aluminum foil by means of a doctor blade so as to attain a coating amount of interest (i.e., 1.0 mg/cm² or 3.1 mg/cm² as reduced to sulfur). Subsequently, the aluminum foil was heated on a hot plate at 40° C. to thereby remove water and dried. Drying was further conducted under reduced pressure for 12 hours. to thereby yield an electrode sheet in which an electrode mixture layer (i.e., a positive electrode mixture layer) was formed on a positive electrode current collector. The thus-obtained electrode sheet was rolled and punched to a piece (120), to thereby provide a positive electrode plate.

### (4) Production of Negative Electrode Plate

A metallic lithium foil having a thickness of 200 μm (product of Honjo Metal Co., Ltd.) was punched to provide a piece (13ϕ), to thereby provide a negative electrode plate.

### (5) Production of a Cell for Performance Evaluation

The positive electrode plate obtained in (3) above and the negative electrode plate obtained in (4) above were disposed by the mediation of a separator (P1F16, product of Asahi Kasei Corporation) so as to oppositely face each other. The stacked body and an electrolytic solution were placed into a stainless steel cell under argon, and the cell was sealed, to thereby yield a cell for evaluation of characteristics. The electrolytic solution employed was prepared by dissolving lithium bis(trifluoromethanesulfonyl)imide (LiTFSI, product of FIJIFILM Wako Pure Chemical Corporation) in a solvent mixture of fluoroethylene carbonate (FEC) and vinylene carbonate (VC) (volume ratio FEC: VC=1:1) to a concentration of 1 mol/L.

### (6) Evaluation

Applicability of electrode mixture layer-forming compositions (electrode slurries) and cracking of each electrode mixture layer were evaluated. Each cell for evaluation was tested in terms of battery characteristics (an output characteristic and a cycle characteristic). The tests were conducted through the following procedures.

### Evaluation of Applicability of Electrode Mixture Layer-Forming Compositions (Applicatability of Electrode Slurry)

The electrode mixture layer-forming composition obtained in (2) above was applied onto an aluminum foil by means of a doctor blade so as to attain a coating amount of 1.0 mg/cm² as reduced to sulfur. The appearance of the aluminum foil was visually observed, and the applicability was evaluated on the basis of the following ratings (passing grade: grade B or better). The applicability of the electrode mixture layer-forming composition of Example 1 was rated as grade A.

A: No anomalous appearance (irregular lines, roughness, etc.) was observed on the surface.

B: Slight anomalous appearance (irregular lines, roughness, etc.) was observed on the surface.

C: Considerably anomalous appearance (irregular lines, roughness, etc.) was observed on the surface.

### Evaluation of Cracking of Electrode Mixture Layer (Cracking of Electrode)

The electrode mixture layer-forming composition obtained in (2) above was applied onto an aluminum foil by means of a doctor blade so as to attain a coating amount of 3.1 mg/cm² as reduced to sulfur. The thus-applied electrode mixture layer-forming composition was dried, and the appearance of the electrode mixture layer was visually observed. Cracking was evaluated on the basis of the following ratings (passing grade: grade B or better). The cracking resistance of the electrode mixture layer-forming composition of Example 1 was rated as grade A.

A: No cracking was observed in the electrode mixture layer.

B: No cracking crossing through the electrode mixture layer was observed, but microcracking was observed.

C: Cracking crossing through the electrode mixture layer was observed.

### Evaluation of Output Characteristics of Cell for Evaluation

A charge/discharge characteristic of the cell for evaluation, produced by applying the electrode mixture layer-forming composition onto aluminum foil in a coating amount of 1.0 mg/cm² (as reduced to sulfur), was measured by means of a charge discharge apparatus (BTS-2000, product of Nagano).

An initial charge/discharge operation was performed via CC discharge at a charge/discharge rate of 0.1 C (1 C=1,672 mA/g) in the range of 1.0 to 3.0 V. Subsequently, the charge/discharge operation was repeated five times at the same charge/discharge rate. The discharge capacity at that timing was defined as X0. Further, 5 cycles of another charge/discharge operation at a rate of 10.0 C were performed, and the discharge capacity at 10.0 C was defined as X1. Through employment of X0 and X1, percent charge/discharge capacity retention (AX) was calculated by the following equation. The output characteristic was evaluated on the basis of the following ratings (passing grade: grade B or better). The greater the value of AX, the greater the discharge capacity at large current (i.e., the more excellent the output characteristics). In Example 1, the percent charge/discharge capacity retention (AX) was 86.5%, corresponding to the rating B in terms of output characteristics.

ΔX=X1/X0×100(%)

### <Ratings of Evaluation>

A: A percent charge/discharge capacity retention of 90.0% or higher.

B: A percent charge/discharge capacity retention of 70.0% or higher and lower than 90.0%

C: A percent charge/discharge capacity retention lower than 70.0%.

### Evaluation of Cycle Characteristics of Cell for Evaluation

A cycle characteristic of the cell for evaluation, produced by applying the electrode mixture layer-forming composition onto aluminum foil in a coating amount of 3.1 mg/cm² (as reduced to sulfur), was evaluated through measurement of charge and discharge in a manner similar to the evaluation of output characteristics.

In the evaluation of cycle characteristics, an initial charge/discharge operation was performed via CC discharge at a charge/discharge rate of 0.1 C in the range of 1.0 to 3.0 V. Subsequently, the charge/discharge operation was repeated once at the same charge/discharge rate, and the initial capacity Y0 was determined. Further, the charge/discharge operation was repeated at the same charge/discharge rate at 25° C., and the capacity Y50 after 50 cycles was determined. Through employment of Y0 and Y50, percent charge/discharge capacity retention (AY) was calculated by the following equation. The cycle characteristic was evaluated on the basis of the following ratings (passing grade: grade B or better). The greater the value of AY, the more excellent the cycle characteristics). In Example 1, the percent charge/discharge capacity retention (AY) was 63.4%, corresponding to the rating B in terms of cycle characteristics.

ΔY=Y50/Y0×100(%)

### <Ratings of Evaluation>

A: A percent charge/discharge capacity retention of 65.0% or higher.

B: A percent charge/discharge capacity retention of 50.0% or higher and lower than 65.0%

C: A percent charge/discharge capacity retention lower than 50.0%.

### Examples 2 to 15

The procedure of Example 1 was repeated, except that the binder was changed to one given in Table 2, to thereby prepare an electrode mixture layer-forming composition (electrode slurry). In the same manner as employed in Example 1, each of the prepared electrode slurries was evaluated in terms of applicability and cracking resistance in the electrode, and battery characteristics (output characteristics and cycle characteristics) of a cell for evaluation were evaluated. Table 2 shows the results.

### Comparative Example 1

In Comparative Example 1, styrene-butadiene rubber (SBR) was used as a binder, instead of the carboxyl group-containing polymer salt. Firstly, an aqueous CMC solution (2.10 g) having the same composition as employed in Example 1 was added to a mixture Mx of a sulfur-containing porous carbon (0.9 g) and a conducting aid (0.05 g), and water (0.3 g) was further added so as to attain an appropriate viscosity. The resultant mixture was kneaded by means of Awatori Rentaro. To the thus-prepared slurry, SBR (TRD2001, product of JSR, solid content: 48.5%) (0.04 g) was added, and the resultant mixture was kneaded again by means of Awatori Rentaro, to thereby form an electrode slurry. The electrode slurry was prepared so that the sulfur-containing porous carbon content, a conducting aid content, a CMC content, and a SBR content were adjusted to 90 mass %, 5 mass %, 3 mass %, and 2 mass %, respectively. The obtained electrode slurry was evaluated in the same manner as employed in Example 1. Table 2 shows the results.

### Comparative Example 2

The procedure of Example 1 was repeated, except that no thickening agent was used, and the carboxyl group-containing polymer salt R-3 was used as a binder, to thereby prepare an electrode slurry. The obtained electrode slurry was evaluated in the same manner as employed in Example 1. Table 2 shows the results.

TABLE 2

| | | | | Example/Comparative Example No. | | | | | |
|---|---|---|---|---|---|---|---|---|---|
| | | | | Example | Example | Example | Example | Example | Example |
| | | | | 1 | 2 | 3 | 4 | 5 | 6 |
| Electrode mixture | active material | sulfur-containing porous | g | 0.90 | 0.90 | 0.90 | 0.90 | 0.90 | 0.90 |
| layer-forming | | carbon | | | | | | | |
| composition | dispersion of | carboxyl group-containing | type | R-1 | R-2 | R-3 | R-4 | R-5 | R-6 |
| (electrode slurry) | binder | polymer (or a salt thereof) | g | 0.02 | 0.02 | 0.02 | 0.02 | 0.02 | 0.02 |
| | | water | g | 0.63 | 0.63 | 0.63 | 0.63 | 0.63 | 0.63 |
| | aqueous | CMC | g | 0.03 | 0.03 | 0.03 | 0.03 | 0.03 | 0.03 |
| | solution of | water | g | 2.07 | 2.07 | 2.07 | 2.07 | 2.07 | 2.07 |
| | thickening agent | | | | | | | | |
| | conducting aid | acetylene black | g | 0.05 | 0.05 | 0.05 | 0.05 | 0.05 | 0.05 |
| | medium | water | g | 0.30 | 0.30 | 0.30 | 0.30 | 0.30 | 0.30 |
| | solid content [mass %] | | | 25% | 25% | 25% | 25% | 25% | 25% |
| Results of | evaluation of | applicatability of electrode slurry | | A | A | A | A | A | A |
| evaluation | electorode | cracking of electrode | | A | A | A | A | A | A |
| | evaluation of | output characteristics | | B | A | A | A | A | A |
| | battery | cycle characteristics | | B | B | B | B | A | A |
| | | | | Example/Comparative Example No. | | | | | |
| | | | | Example | Example | Example | Example | Example | Example |
| | | | | 7 | 8 | 9 | 10 | 11 | 12 |
| Electrode mixture | active material | sulfur-containing porous | g | 0.90 | 0.90 | 0.90 | 0.90 | 0.90 | 0.90 |
| layer-forming | | carbon | | | | | | | |
| composition | dispersion of | carboxyl group-containing | type | R-7 | R-8 | R-9 | R-10 | R-11 | R-12 |
| (electrode slurry) | binder | polymer (or a salt thereof) | g | 0.02 | 0.02 | 0.02 | 0.02 | 0.02 | 0.02 |
| | | water | g | 0.63 | 0.63 | 0.63 | 0.63 | 0.63 | 0.63 |
| | aqueous | CMC | g | 0.03 | 0.03 | 0.03 | 0.03 | 0.03 | 0.03 |
| | solution of | water | g | 2.07 | 2.07 | 2.07 | 2.07 | 2.07 | 2.07 |
| | thickening agent | | | | | | | | |
| | conducting aid | acetylene black | g | 0.05 | 0.05 | 0.05 | 0.05 | 0.05 | 0.05 |
| | medium | water | g | 0.30 | 0.30 | 0.30 | 0.30 | 0.30 | 0.30 |

| | solid content [mass %] | | 25% | 25% | 25% | 25% | 25% | 25% |
|---|---|---|---|---|---|---|---|---|
| Results of | evaluation of | applicatability of electrode slurry | B | B | A | A | A | A |
| evaluation | electorode | cracking of electrode | A | B | A | A | A | A |
| | evaluation of | output characteristics | B | B | B | A | A | A |
| | battery | cycle characteristics | A | A | A | A | B | B |

| | | | | Example/Comparative Example No. | | | | |
|---|---|---|---|---|---|---|---|---|
| | | | | Example | Example | Example | Comparative | Comparative |
| | | | | 13 | 14 | 15 | Example 1 | Example 2 |
| Electrode mixture | active material | sulfur-containing porous | g | 0.90 | 0.90 | 0.90 | 0.90 | 0.90 |
| layer-forming | | carbon | | | | | | |
| composition | dispersion of | carboxyl group-containing | type | R-13 | R-14 | R-15 | SBR | R-3 |
| (electrode slurry) | binder | polymer (or a salt thereof) | g | 0.02 | 0.02 | 0.02 | 0.04 | 0.05 |
| | | water | g | 0.63 | 0.63 | 0.63 | | 0.63 |
| | aqueous | CMC | g | 0.03 | 0.03 | 0.03 | 0.03 | |
| | solution of | water | g | 2.07 | 2.07 | 2.07 | 2.07 | 2.07 |
| | thickening agent | | | | | | | |
| | conducting aid | acetylene black | g | 0.05 | 0.05 | 0.05 | 0.05 | 0.05 |
| | medium | water | g | 0.30 | 0.30 | 0.30 | 0.30 | 0.30 |

| | solid content [mass %] | | 25% | 25% | 25% | 29% | 25% |
|---|---|---|---|---|---|---|---|
| Results of | evaluation of | applicatability of electrode slurry | A | A | A | A | C |
| evaluation | electorode | cracking of electrode | A | A | A | C | B |
| | evaluation of | output characteristics | B | B | B | C | Not evaluate |
| | battery | cycle characteristics | B | B | B | C | Not evaluate |

Details of the compounds shown in Table 2 are as follows.
SBR: styrene-butadiene rubber
CMC: carboxymethylcellulose sodium

### 3. Results of Evaluation

As is clear from Table 2, the electrode mixture layer-forming compositions (electrode slurries) of Examples 1 to 15, each containing a carboxyl group-containing polymer (or a salt thereof) serving as a binder, a sulfur-based active material, a thickening agent, and water, exhibited suitable applicability. In the electrode mixture layer formed by use of any of the electrode mixture layer-forming compositions of Examples 1 to 15, no cracking was observed, or a tiny cracking was observed. In addition, output characteristics and cycle characteristics of the lithium-sulfur secondary battery formed from the compositions were satisfactory.

Being focused on the binder, regarding the monomer(s) forming the carboxyl group-containing polymer (or a salt thereof), when a carboxyl group-containing polymer (or a salt thereof) including a structural unit derived from the monomer (B) was used (Examples 1 to 6, and 9 to 14), more suitable electrode slurry applicability was attained, as compared with the case in which a carboxyl group-containing polymer (or a salt thereof) including no structural unit derived from the monomer (B) was used (Examples 7 and 8). Being focused on the carboxyl group-containing polymer (or a salt thereof) including a structural unit derived from the monomer (B), regarding the solubility of the monomer (B) in 100 g of water at 20° C., when the solubility was 10 g or higher (Examples 5 and 6), more suitable cycle characteristics of the lithium-sulfur secondary battery were attained, as compared with the case in which the solubility was lower than 10 g (Examples 1 to 4).

Also, being focused in the presence of cross-linking in the carboxyl group-containing polymer (or a salt thereof), when a cross-linked polymer was used (Example 7), generation of cracking in the electrode mixture layer was suppressed, and more suitable electrode cracking resistance was achieved, as compared with the case in which a non-cross-linked polymer was used (Example 8).

In contrast, in Comparative Example 1 employing no carboxyl group-containing polymer (or a salt thereof) serving as a binder, cracking resistance of the electrode formed from the electrode slurry, and output characteristics and cycle characteristics of the lithium-sulfur secondary battery were inferior to those achieved in Examples 1 to 15. Also, in Comparative Example 2 employing no thickening agent, the sulfur-based active material was not sufficiently dispersed in the electrode slurry, and applicability of the electrode slurry and cracking resistance of the electrode formed from the electrode slurry were inferior to those achieved in Examples 1 to 15. Thus, an electrode allowing battery performance evaluation was failed to be produced.

The present invention is not limited to the aforementioned embodiments. Needless to say, the present invention encompasses various modifications and those falling within the equivalents thereof, so long as they are not deviated from the gist of the present invention. Thus, it should be construed that, in view of the above teaching, those skilled in the art could conceive various combinations, modes, and further embodiments of a single element or a combination including the element or its equivalent, which also fall within the scope or concept of the present invention.

1. An electrode mixture layer-forming composition for a lithium-sulfur secondary battery,
which composition comprises a carboxyl group-containing polymer or a salt thereof serving as a binder,
a sulfur-based active material,
a thickening agent, and
water.

2. The electrode mixture layer-forming composition according to claim 1,
wherein the carboxyl group-containing polymer comprises a structural unit (UA) derived from an ethylenically unsaturated monomer and having a carboxyl group, and
the carboxyl group-containing polymer comprises the structural unit (UA) in a relative amount, with respect to all the structural units of the carboxyl group-containing polymer, of 50 mass % or more.

3. The electrode mixture layer-forming composition according to claim 1,
wherein the carboxyl group-containing polymer comprises a structural unit derived from an ethylenically unsaturated monomer (B) having no carboxyl group (except for a cross-linkable monomer), and
the carboxyl group-containing polymer comprises the structural unit derived from an ethylenically unsaturated monomer (B) in a relative amount, with respect to all the structural units of the carboxyl group-containing polymer, of 1 mass % to 50 mass %.

4. The electrode mixture layer-forming composition according to claim 3, which comprises an ethylenically unsaturated monomer having a solubility of 10 g or more in 100 g of water at 20° C., as the ethylenically unsaturated monomer (B).

5. The electrode mixture layer-forming composition according to claim 1, wherein the carboxyl group-containing polymer is a cross-linked polymer.

6. The electrode mixture layer-forming composition according to claim 5, wherein the cross-linked polymer comprises a structural unit derived from a cross-linkable monomer and a structural unit derived from a non-cross-linkable monomer.

7. The electrode mixture layer-forming composition according to claim 6, wherein the cross-linked polymer comprises the structural unit derived from a cross-linkable monomer in a relative amount, with respect to the entire amount of the structural unit derived from a non-cross-linkable monomer, of 0.1 mol % to 2.0 mol %.

8. The electrode mixture layer-forming composition according to claim 5, wherein the cross-linked polymer has a particle size of 0.1 μm to 7.0 μm as a volume-basis median diameter, as determined in a water medium after neutralization to a neutralization degree of 80 mol % or higher.

9. The electrode mixture layer-forming composition according to claim 1, which comprises a substituted product of a cellulose-based water-soluble polymer in which at least a part of hydroxy groups have been substituted by a carboxymethyl group, or a salt thereof, as the thickening agent.

10. The electrode mixture layer-forming composition according to claim 1, which comprises at least one of elemental sulfur and a sulfur-based compound as the sulfur-based active material.

11. The electrode mixture layer-forming composition according to claim 10, wherein the sulfur-based compound is a carbon-sulfur composite in which sulfur is supported by pores of a porous carbon powder having a mean pore size of 100 nm or smaller.

12. The electrode mixture layer-forming composition according to claim 1, which further comprises a conducting aid.

13. An electrode of a lithium-sulfur secondary battery, the electrode comprising a current collector, and an electrode mixture layer disposed on a surface of the current collector,
wherein the electrode mixture layer is formed from the electrode mixture layer-forming composition as recited in claim 1.

14. A lithium-sulfur secondary battery comprising the lithium-sulfur secondary battery electrode as recited in claim 13.
